(19) United States
(12) Patent Application Publication
(10) Pub. No.: US 2004/0051610 A1
(43) Pub. Date: Mar. 18, 2004

(54) Method and apparatus for electromagnetically magnetizing and demagnetizing metallic tool shafts

(76) Inventor: Paul Sajan, Berkeley, CA (US)

Correspondence Address: Paul Sajan, 5963 Chabolyn Ter, Oakland, CA, 94618, US

(21) Appl. No.: 10/245,734

(22) Filed: Sep. 17, 2002

(51) Int. Cl. H01F 7/20

(52) U.S. Cl. 335/284

(57) ABSTRACT

A compact electric device for magnetizing and demagnetizing metal shafts, screwdrivers, or metallic tools using stored electrical energy. Handheld portable versions are illustrated (see FIGS. 1, 1A, 2, and 2A). The end of a metal shaft, or screwdriver shaft, or other said instrument is placed in (see FIGS. 3 and 6) a receiving cavity or socket (96) which is the hollow center within two coils L1 (80) and L2 (82). The operator of the device chooses either demagnetization or magnetization via a switch (86), presses an action switch (88), and electric current flows through the coils and the rest of the device in a precise way to produce the desired effect of either magnetization or demagnetization. The inserted metal shaft or other said instrument may then be removed from the receiving cavity and is now either magnetized or demagnetized. Electric power is provided by one of three methods: hand-powered push lever AC power generator, DC batteries, or AC/DC converter connected to an external power connector (94). The application range of the hand-held electric magnetizer/demagnetizer is wider.

### CROSS-REFERENCE TO RELATED APPLICATIONS

Not applicable.

1. Background—Field of Invention

This invention relates to magnetizing/demagnetizing devices, specifically to a compact, fast, powerful, electric metallic shaft magnetizer/demagnetizer.

2. Background—Description of Prior Art

Technicians, mechanics, hobbyists, or anyone wishing to service any machine or apparatus often desire or require the magnetization of their instruments which contain metallic shafts such as screwdrivers, screwdriver bits, tweezers, allen wrench, etc.

Conversely, there are instances in which a magnetized driver bit tip or other said instrument is a disadvantage, because it undesirably attracts and attaches to itself various magnetizable elements or components. Under such circumstances, it may be desirable to demagnetize said instrument that had been originally magnetized in order to render it magnetically neutral.

A conventional screwdriver 110 is shown in FIG. 8. Screwdrivers are often magnetized during the manufacturing process. Either the entire metallic shaft ill or the front end of the metallic shaft is magnetized to form a magnetized section 112. Over time, the level of magnetism will degrade. If the shaft 111 is subjected to high temperatures or violent shaking, the magnetism will often degrade or even completely disappear.

Devices for magnetizing/demagnetizing tools and small parts are well known. These normally incorporate one or more permanent magnets which create a sufficiently high magnetic field to magnetize at least a portion of a magnetizable element brought into its field. The body can be magnetized by bringing it into the magnetic field. While the magnetic properties of all materials make them respondent in some way to magnetic fields, most materials are diamagnetic or paramagnetic and show almost no response to magnetic fields. However, a magnetizable element made of a ferromagnetic material readily responds to a magnetic field and becomes, at least temporarily, magnetized when placed in such a magnetic field.

Most magnetizers/demagnetizers include commercial magnets which are formed of either Alnico or of ceramic materials. The driver members/fasteners, on the other hand, are normally made of soft materials which are readily magnetized but more easily lose their magnetization, such as by being drawn over an iron or steel surface, subjected to a demagnetizing influence such as strong electromagnetic fields or other permanent magnetic fields, severe mechanical shock or extreme temperature variations.

One example of a stand alone magnetizer/demagnetizer is magnetizer/demagnetizer Model No. 40010, made in Germany by Wiha. This unit consists of a plastic box that has two adjacent openings defined by three spaced transverse portions. Magnets are placed within the transverse portions to provide magnetic fields in each of the two openings which are directed in substantially opposing directions. Therefore, when a magnetizable tool bit or any magnetizable component is placed within one of the openings, it becomes magnetized and when placed in the other of the openings, it becomes demagnetized. The demagnetizing window is provided with progressive steps to stepwise decrease the air gap for the demagnetizing field and, therefore, provides different levels of strengths of the demagnetizing field.

Another example of a stand alone magnetizer/demagnetizer is U.S. Pat. No. 6,249,199 to Liu (2001). Shown in FIG. 9, it consists of a casing 120 which contains two magnets and a cavity or socket 122 between the magnets for insertion of a screwdriver. When the metallic stem 112 of the screwdriver 110 is abraded back and forth against the demagnetizing face of the outer casing and at the same time rotated, the screwdriver is demagnetized. When the screwdriver is placed inside the cavity, and abraded back and forth therein and rotated at the same time, the screwdriver is magnetized.

An example of an integrated magnetizer is U.S. Pat. No. 6,026,718 to Anderson (2000). It consists of a magnetizer/demagnetizer for integration with a non-operative portion of a hand-held driving tool or the like, The driving tool has at least one permanent magnet provided on the handle.

All the magnetizer/demagnetizers heretofore known and other similar magnetizer/demagnetizers which utilize magnets to achieve magnetization/demagnetization suffer from a number of disadvantages:

(a) the use of magnets in magnetizer/demagnetizers makes such a tool a danger in itself around sensitive electronic and/or magnetic equipment such as computers, memory components, video tapes, disks, memory sticks, credit card, etc. Placement near said sensitive equipment could cause damage to such equipment.

(b) the use of magnets in magnetizer/demagnetizers makes such a tool a danger in itself if left on top of, or very close to any monitor, causing distortion of picture quality, often requiring degaussing or service by qualified repairman. Some watches, or other fine, delicate, precise, and/or scientific machinery/instruments can be made inoperative or out of alignment.

(c) the use of magnets in magnetizer/demagnetizers makes such a tool a major attractor of other metallic objects. If such a tool is used in an environment which contains metal shavings, keeping the magnetizer/demagnetizer clean can become a serious effort. For highly sensitive applications where fine metallic objects such as shavings are undesired, once a magnetizer/demagnetizer becomes polluted with metallic shavings it can no longer be used in such a setting and must be replaced. Another problem related to unwanted attraction can be witnessed in crammed tool boxes as the magnetizer/demagnetizer surrounded by other tools tend to stick one another.

(d) the magnetization and demagnetization process can often involve a collection of various complex motions that must be performed in addition to simple insertion. Depending on the magnetizer/demagnetizer the process can be complex, and not always reliable.

### OBJECTS AND ADVANTAGES

Accordingly, several objects and advantages of the present invention are:

(a) to provide a magnetizer/demagnetizer whose physical placement or proximity is not a danger to any sensitive electronic and/or magnetic equipment such as computers, memory components, video tapes, disks, memory sticks, etc.

(b) to provide a magnetizer/demagnetizer whose physical placement or proximity is not a danger to any monitor, watch, or other fine, delicate, precise, and/or scientific machinery/instruments.

(c) to provide a magnetizer/demagnetizer which is not constantly magnetic, and thus not an attractor of metallic shavings, metallic tools or other metallic objects.

(d) to provide a magnetizer/demagnetizer whose magnetization and demagnetization process does not require a collection of various complex motions that must be performed by the users Operation of the tool is reliable, simple, and straightforward.

Further objects and advantages are:

(i) to provide a magnetizer/demagnetizer which performs the magnetization and demagnetization processes only when the user wishes it to.

(ii) to provide a magnetizer/demagnetizer which is electrically powered, but is hand-held, portable and mobile—does not need to be connected to a powder outlet.

(iii) to provide a magnetizer/demagnetizer when utilized in connection with rotating shafts of various machinery to assist in gear switching by engaging and disengaging connecting shafts.

(iv) to provide independent magnetizing and demagnetizing process universally applicable to many more uses.

(v) to provide repeatable magnetizing and demagnetizing in rapid succession limited by available power supply. Hand powered and battery powered units are capable of repeating either process every 3-4 seconds.

(vi) still further objects and advantages will become apparent from a consideration of the ensuing description and drawings.

### DRAWING FIGURES

In the drawings, closely related figures have the same number but may have an additional different alphabetic suffix.

FIG. 1 shows front and side views of a hand-held hand-powered magnetizer/demagnetizer unit.

FIG. 1A shows the same things as FIG. 1, except it is labeled.

FIG. 2 shows front and side views of a hand-held battery-powered or optional AC/DC (alternating current/direct current) powered magnetizer/demagnetizer unit.

FIG. 2A shows the same things as FIG. 2, except it is labeled.

FIG. 3 is a drawing of the actual coil assembly showing a shaft of a screwdriver inserted in the socket within the coils.

FIG. 4 is a detailed schematic of a hand-held hand-powered magnetizer/demagnetizer.

FIG. 5 is a detailed schematic of a hand-held hand-powered magnetizer only.

FIG. 6 is a detailed schematic of a battery-powered or optional AC/DC powered magnetizer/demagnetizer.

FIG. 7 is a detailed schematic of a battery-powered or optional AC/DC red magnetizer only.

FIG. 8 is a perspective view of a conventional magnetized screwdriver or art).

FIG. 9 shows the demagnetization operation of a screwdriver with a magnet based magnetizer/demagnetizer, specifically for the unit described in U.S. Pat. No. 6,249,199 to Liu (2001) (prior art).

REFERENCE NUMERALS IN DRAWINGS

| | | | |
|---|---|---|---|
| 10 | hand-powered AC | 12 | C1 electrolytic capacitor 470 μF |
| | generator | | |
| 14 | C2 electrolytic capacitor | 16 | D1 silicon diode 50 V PRV |
| | 10000 μF | | (peek reverse voltage) 1A |
| 18 | D2 Silicon diode 50 V | 20 | Z1 Zener diode 16 V 0.5 W |
| | PRV 1A | | |
| 22 | Z2 Zener diode 15 V | 24 | LED1 green LED - charge |
| | 0.5 W | | indicator |
| 26 | LED2 bright red LED - | 28 | Q1 SCR (silicon control |
| | action indicator | | rectifier) - discharge switch |
| 30 | R1 10 kohms 0.5 W | 32 | 330 ohms 0.5 W resistor |
| | resistor | | |
| 34 | R3 680 ohms 0.5 W | 40 | S1 function selection DPDT |
| | resistor | | switch |
| 42 | lever used on hand- | 44 | outer casing for hand-powered |
| | powered AC generator | | unit |
| 46 | outer casing for the coils | | |
| | assembly - note the coils | | |
| | assembly is just the | | |
| | two coils L1 (80) | | |
| | and L2 (82) together. | | |
| 50 | CN1 9 V battery | 52 | CN2 9 V battery connector |
| | connector | | |
| 54 | R1 220 ohms 1 W | 56 | R2 18 kohms 0.5 W resistor |
| | resistor | | |
| 58 | R3 18 kohms 0.5 W | 60 | R4 3.3 kohms 0.5 W resistor |
| | resistor | | |
| 62 | R5 1 kohm 0.5 W | 64 | R6 680 ohms 0.5 W resistor |
| | resistor | | |
| 66 | C1 electrolytic capacitor | 68 | LED1 green LED - ready |
| | 11000 μF | | indicator |
| 70 | LED2 red LED - action | 72 | LED3 green LED - charge |
| | indicator | | indicator |
| 74 | Z1 Zener diode 15 V | 76 | Z2 Zener diode 12 V 0.5 W |
| | 0.5 W | | |
| 78 | Q1 SCR - discharge | 80 | L1 coil - 74 turns, 0.5 mm, |
| | switch | | copper wire |
| 82 | L2 coil - 74 turns, | 84 | R7 2.2 kohms 0.5 W resistor |
| | 0.5 mm, copper wire | | |
| 86 | S1 function selection | 88 | S2 Charge or Action/Off DPDT |
| | DPDT switch | | switch |
| 90 | IC1 charge indicator | 92 | D1 polarity protective silicon |
| | control chip (opamp - | | diode 400 V PRV 1A |
| | LM741) | | |
| 94 | CN3 19 V DC external | 96 | shaft socket |
| | power connector | | |
| 98 | outer casing for battery | | |
| | powered unit | | |
| 110 | screwdriver | 112 | metallic shaft |
| 114 | magnetic section of shaft | | |
| 120 | outer casing which | 122 | screwdriver socket |
| | contains one magnet | | |

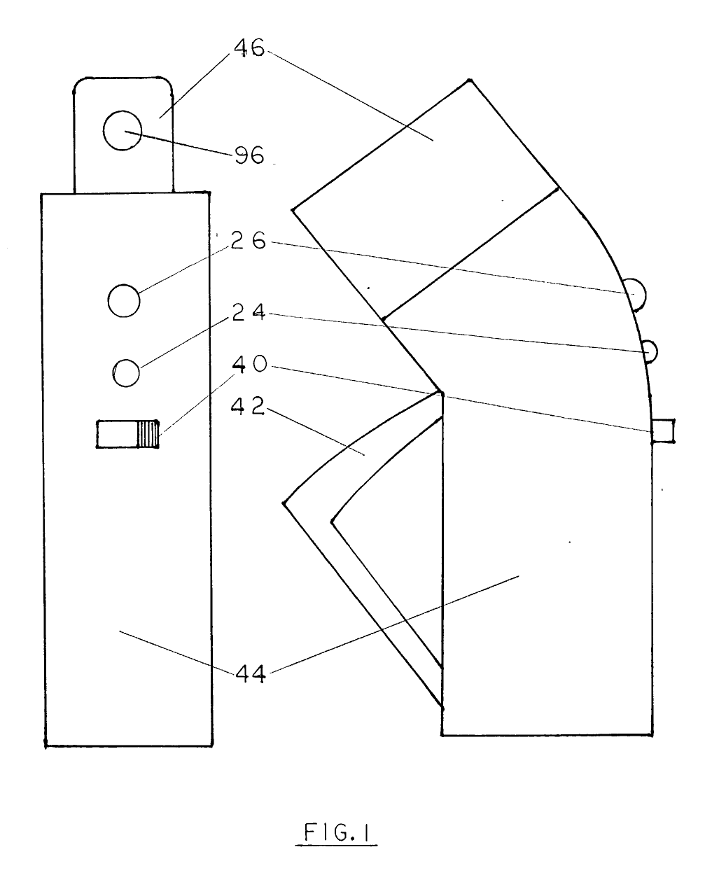

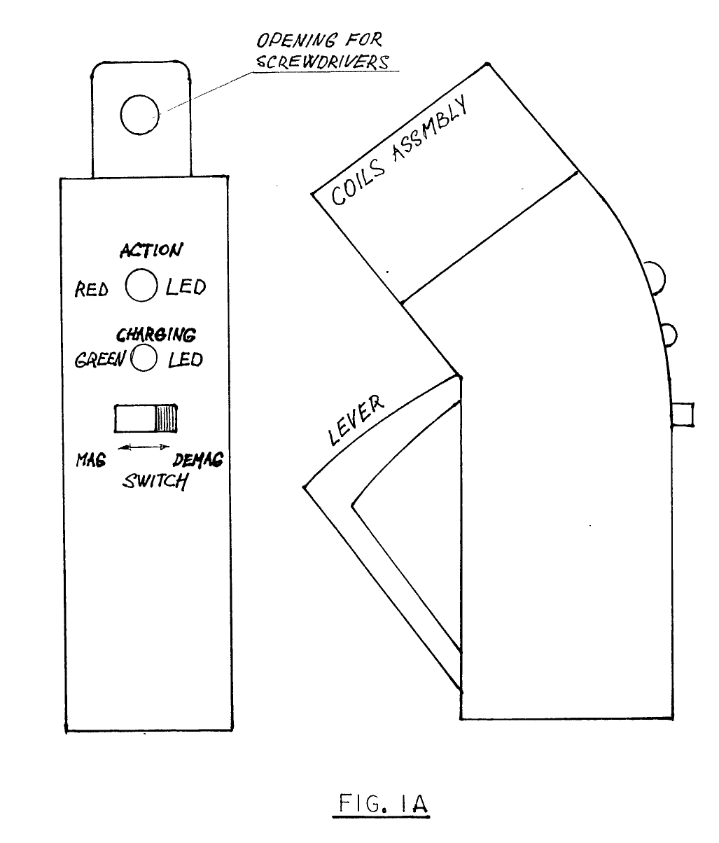

### DESCRIPTION—FIGS 1, 1A, 3, 4 AND 5—PREFERRED EMBODIMENT

A preferred embodiment of the magnetizer/demagnetizer of the present invention is illustrated in FIG. 1 (includes two views: front and side). Note that FIG. 1A is the same drawing however with labels also drawn to assist in the illustration of the invention. Refer to FIG. 1 when locating reference numerals regarding the exterior description. These figures show the hand-held hand-powered magnetizer/demagnetizer. The invention is contained in a modified hand-powered AC generator casing 44.

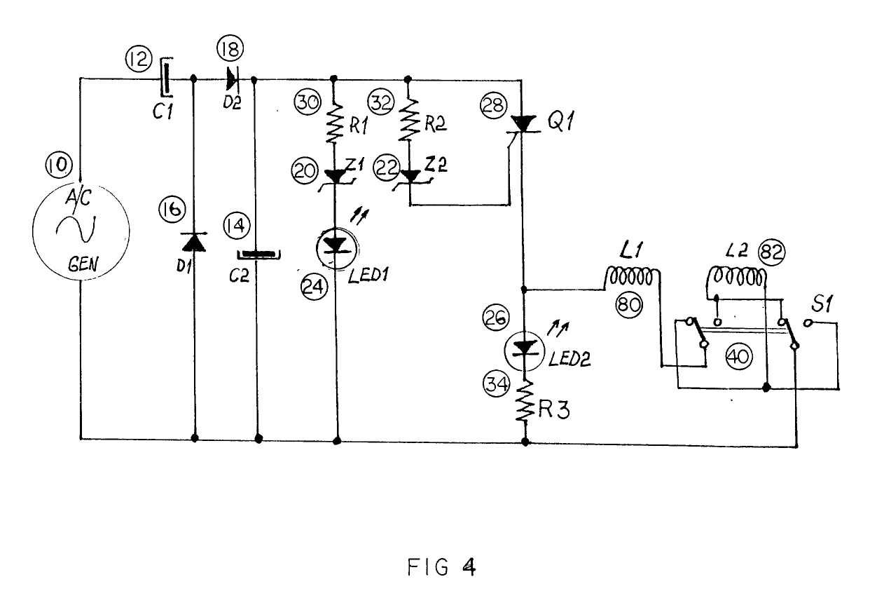

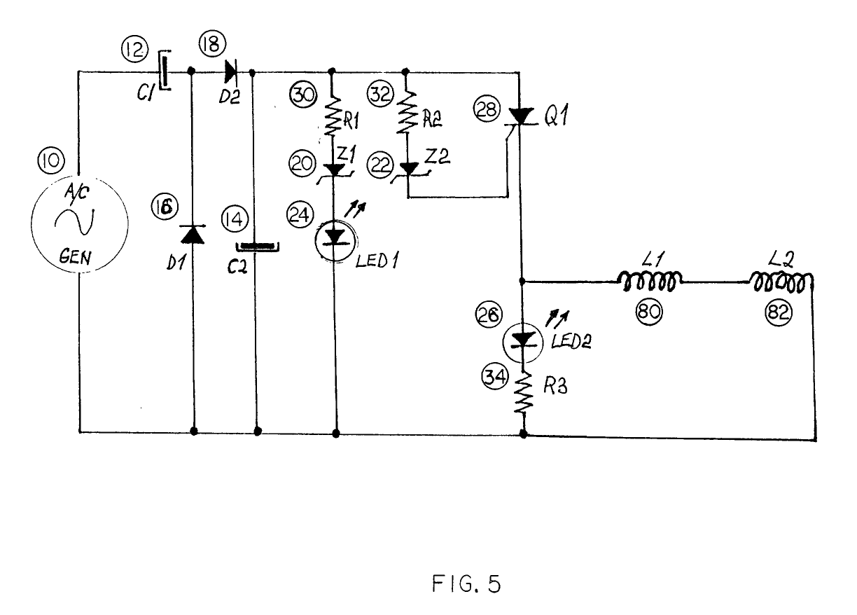

Notice the lever 42 which is used to power the AC generator 10 (see FIG. 4 and 5). The AC generator is contained inside the casing. The user would repeatedly press and release on the lever which has teeth which drive gears connected to a dynamo which generates electricity. The type of levers dynamo, or combination of the two is considered prior art and is used in conjunction with the invention as a source of electric power.

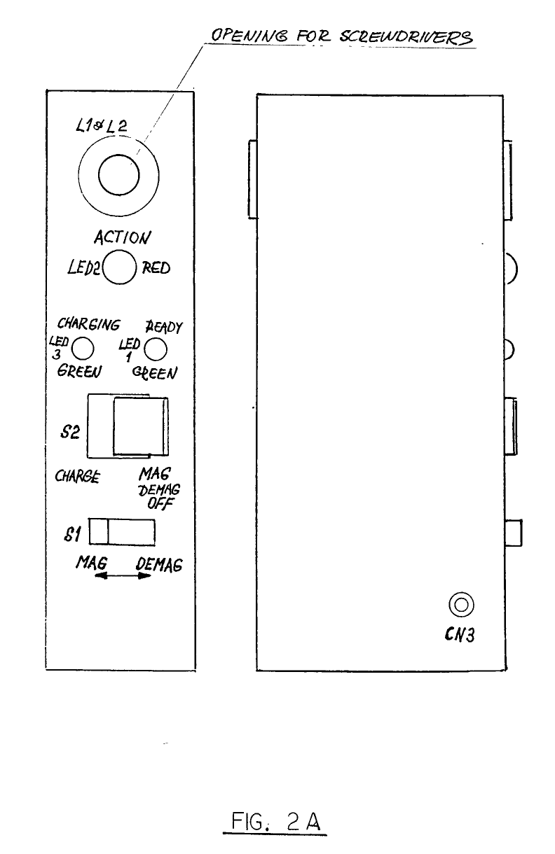

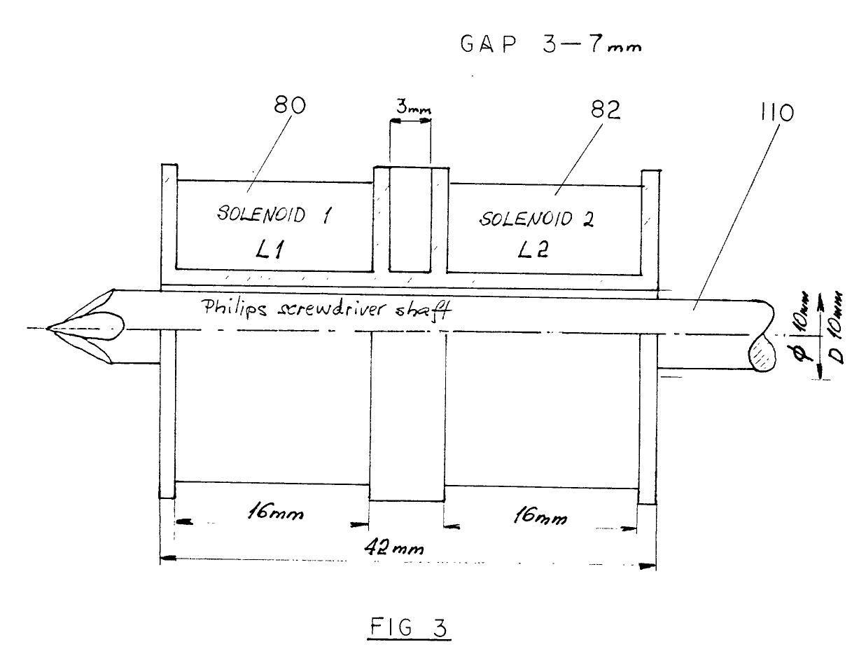

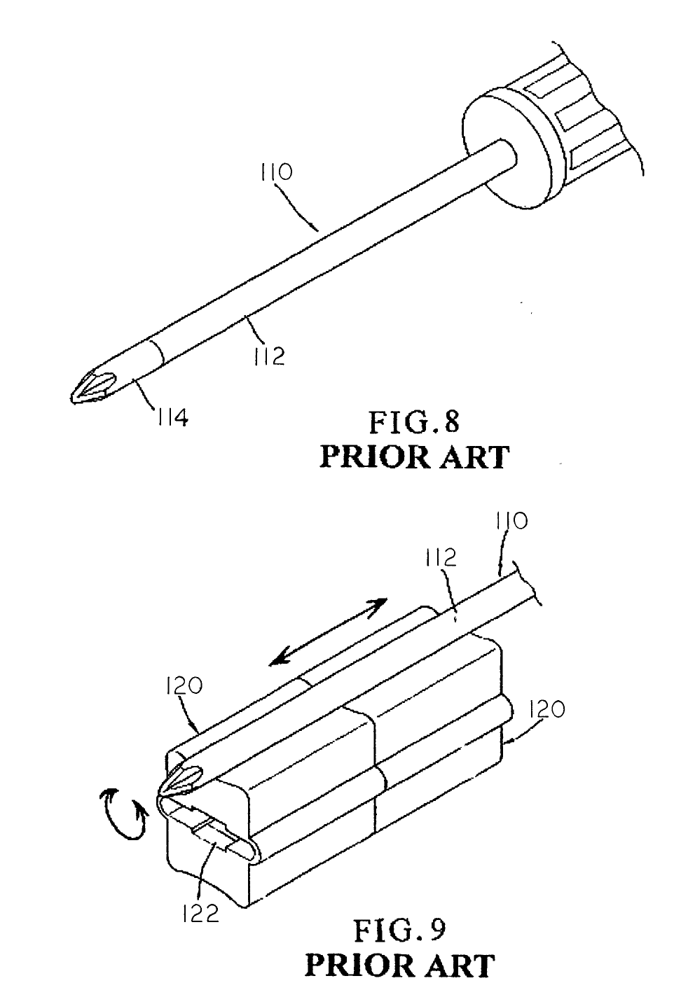

Besides the said lever, FIG. 1 shows the exterior of the invention. At the top of magnetizer/demagnetizer unit, a receptacle, cavity or socket 96 to receive one end of a metallic shaft, metallic instrument shafts, or a screwdriver shaft 112 (see FIG. 8) is provided. The socket is the hollow area inside the two coils L1 80 and L2 82. The two coils, also refered to as the “coils assembly”, are contained inside the outer casing for the coils assembly 46. FIG. 3 clearly shows an inserted screwdriver shaft 112 inside the two coils L1 80 and L2 82. These coils are contained inside the casing 44 shown in FIG. 1. A red LED 26, indicating action, protrudes through the casing. A green LED 24, indicating charge, protrudes through the casing. A switch 40 for choosing either the magnetization or demagnetization function also protrudes through the casing. The outer casing 44 is typically about 65 mm long, 30 mm wide, and 130 mm high. The outer casing for the coils assembly 46 is 50 mm long, 20 mm wide, 20 mm high.

The rest of the invention lies within the casing and is best illustrated by the schematic in FIG. 4. Notice the placement of the hand powered AC generator 10 in the schematic, which is the source of electric energy for the hand-powered hand-held magnetizer/demagnetizer. It is connected to a capacitor 12 C1 and a silicon diode 16 D1. These are further connected to a silicon diode 18 D2 and a storage capacitor 14 C2. So 12, 16, 18, and 14 form a “voltage doubler” or “doubler circuitry”. To the right of the voltage doubler, only DC voltage is present. The line at the top of the schematic can be considered the positive line, and the line at the bottom of the schematic can be considered the common or negative line. This is connected to a resistor 30 R1, which is connected to a Zener diode 20 Z1, which is connected to a green LED 24 LED1, which is connected to the negative line. Further along the positive line, a resistor 32 R2 is connected. This resistor is connected to a Zener diode 22 Z2, which is connected to the gate of SCR (silicon control rectifier) 28 Q1. The positive line is connected to the SCR at its anode connection on one side. The SCR's cathode connection is connected to a line which is connected to the coil 80 L1, and also a red LED 26 LED2. The coil 80 L1 is connected to the magnetize/demagnetize switch 40 S1, which is connected to the second coil 82 L2. The output of switch S1 is connected to the negative line. The red LED 26 LED2 is connected to a limiting resistor 34 R3 which in turn is connected to the negative line.

A schematic which provides a design for a magnetizer only (no demagnetizer option available) is shown in FIG. 5. Notice that the schematic is exactly the same as the schematic in FIG. 4, except that the magnetize/demagnetize switch 40 S1 has been removed from the circuit.

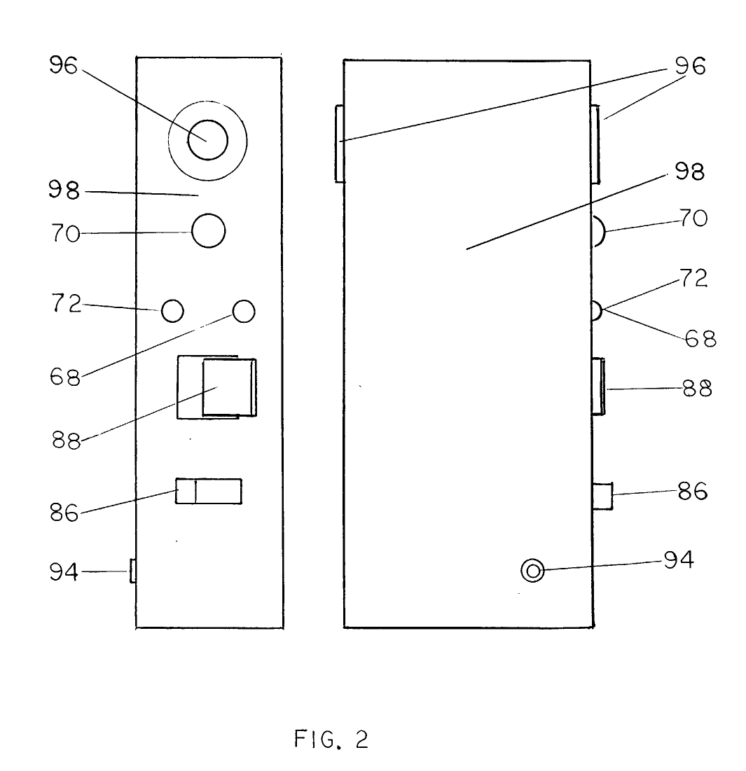

### FIGS. 2, 2A, 3, 6 AND 7—ADDITIONAL EMBODIMENTS

Additional embodiments are shown in FIGS. 2, 2A, 6 and 7. FIG. 2 shows two exterior views: front and side. Note that FIG. 2A is the same drawing however with labels also drawn to assist in the illustration of the invention. Refer to FIG. 2 when locating reference numerals regarding the exterior description. These figures show the hand-held battery-powered magnetizer/demagnetizer. The invention is contained in a casing 98.

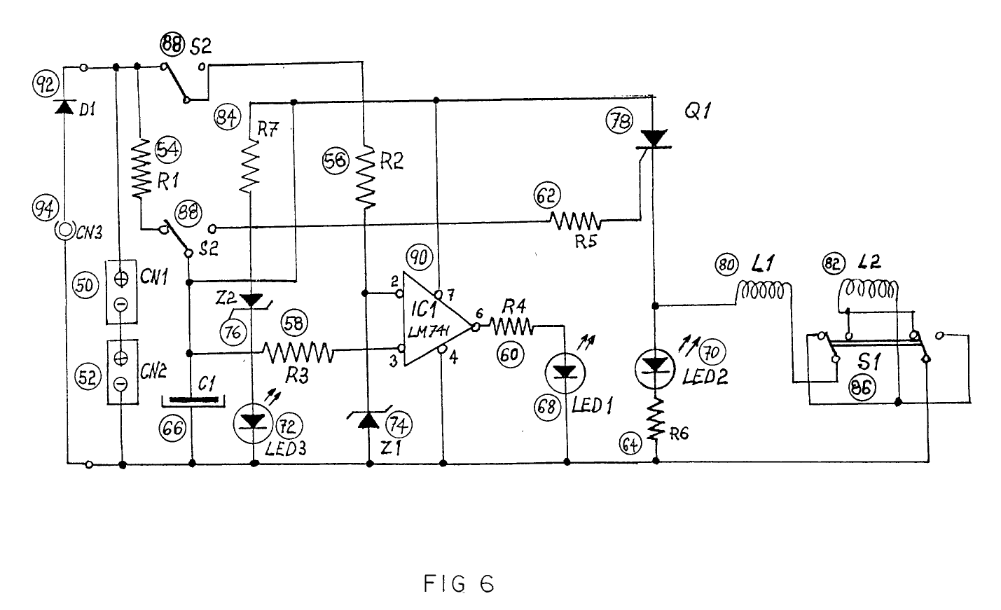

Notice the CN3 AC/DC external power connector 94. This provides an optional external power source other than the power provided by the internal batteries (location for installing two batteries can be seen in FIG. 6, at locations CN1 50 and CN2 52).

FIG. 2 shows the exterior of the invention. At the top of magnetizer/demagnetizer unit, a receptacle, cavity or socket 96 to receive one end of a metallic shaft, metallic instrument shafts, or a screwdriver shaft 112 (see FIG. 8) is provided. The socket is the hollow area inside the two coils L1 80 and L2 82. FIG. 3 clearly shows an inserted screwdriver shaft 112 inside the two coils L1 80 and L2 82. These coils are contained inside the casing 98 shown in FIG. 2. A red LED 70, indicating action, protrudes through the casing. A green LED 72, indicating charge, protrudes through the casing. Another green LED 68, indicating the magnetizer/demagnetizer is ready for action, protrudes through the casing. A switch 88 for charging the magnetizer/demagnitzer and action/off also protrudes through the casing. A switch 86 for choosing either the magnetization or demagnetization function also protrudes through the casing. The outer casing 98 is typically about 65 mm long, 30 mm wide, and 130 mm high.

The rest of the invention lies within the casing and is best illustrated by the schematic in FIG. 6. Notice the placement of the AC/DC external power connector 94 CN3. It is connected to a protective diode 92 D1. Parallel to CN3 and D1 are connected two 9V battery connectors 50 CN1 and 52 CN2. The positive line from CN1 and CN2 connects to a resistor 54 R1 and a DPDT switch 88 S2. From this point onwards, there are two branches of the circuit: the charging branch and the discharge/action branch.

The charging branch is active when the DPDT switch 88 S2 is connecting this branch to the power circuitry (battery connectors 50 and 52, or external power connector 94). The lower pole of the DPDT switch is connected to a storage capacitor 66 C1. Prior to C1 a resistor 58 R3 is connects the line to pin 3 of pin 3 of IC (LM741) 90 IC1. Output pin 6 of IC1 connects to resistor 60 R4 which is connected to a green LED 68 LED1. Prior to R3 is a connection to a resistor 84 R7 connected to the anode connection of Zener diode 76 Z2. The cathode connection of Z2 is connected to the anode of a green LED 72 LED3. The upper pole of the DPDT switch 88 S2 connects to a resistor 56 R2 to pin 2 of IC1. R2 is further connected to Zener diode 74 Z1.

The discharge/action branch is active only when the DPDT switch 88 S2 is disconnected from the positive line of the power circuitry (battery connectors 50 and 52, or external power connector 94). When S2 is in this position, it allows the capacitor 66 Cl to discharge through resistor 62 R5 which is connected to the gate of SCR 78 Q1. This allows charge to move through Q1 to the coil 80 L1. L1 is connected to a DPDT switch 86 S1 which selects either magnetize or demagnetize. S1 is also connected to the second coil 82 L2. Prior to the coil L1, Q1 is also connected to a red LED 70 LED2, which is connected to a resistor 64 R6.

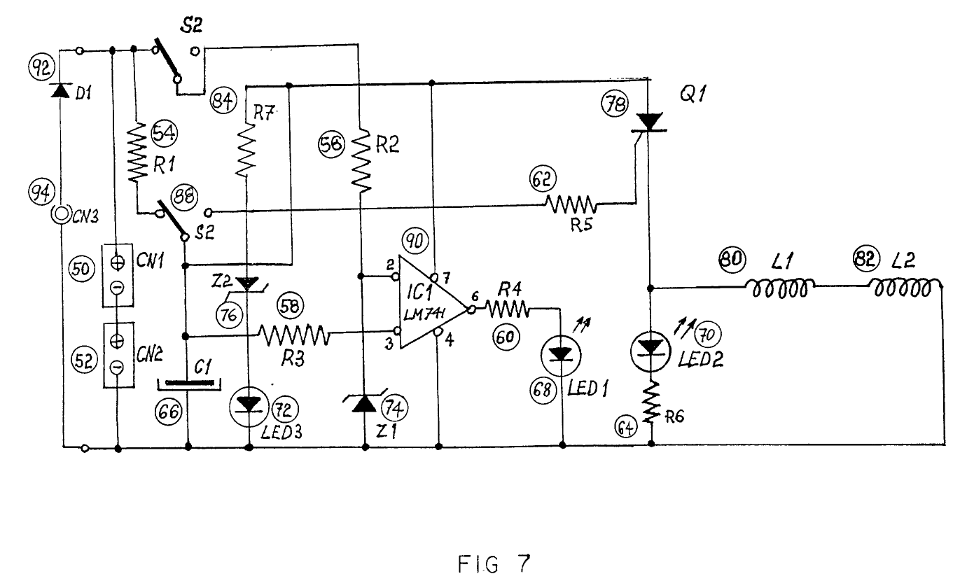

A schematic which provides a design for a magnetizer only (no demagnetizer option available) is shown in FIG. 7. Notice that the schematic is exactly the same as the schematic in FIG. 6, except that the DPDT magnetize/demagnetize switch 86 S1 has been removed from the circuit.

### FIGS. 3, 6 AND 7—ALTERNATIVE EMBODIMENTS

There are various possibilities with regard to the placement of the electronic components contained in the schematics found in FIGS. 6 or 7, in a variety of different machinery, devices and/or processes which desire the magnetization/demagnetization of ferromagnetic shafts within such machinery, devices, and/or processes. The outer casing and perhaps even the LED circuitry would not be needed. A higher output AC generator could be used allowing the removal or modification of the voltage doubler, and the addition of a voltage rectifier.

The above mentioned embodiments are only used to illustrate the present invention, not intended to limit the scope thereof. Many modifications of the above embodiments can be made without departing from the spirit of the present invention.

Advantages

From the description above, a number of advantages of my electric magnetizer/demagnetizer become evident:

(a) the magnetizer/demagnetizer produces a magnetic field only at a specific instant of time—only when the circuitry involved with the action state is active, and only when the user switches the device to do such action. This is an extremely short period of time, and depending on the coil assembly casing, shielding can be included to further shield the surroundings from the short-lived magnetic field produced by the coils. This will allow for safe storage and usage of the device around sensitive electronic and/or magnetic equipment such as computers, memory components, video tapes, disks, memory sticks, etc.

(b) for the same reasons as in (a) above, the magnetizer/demagnetizer's proximity during storage or even the charging phase is not a danger to any monitor, watch, or other fine, delicate, precise, and/or scientific machinery/instruments. Only during the extremely short action phase can some small momentary interference be noticed, especially if used in very close proximity to said machinery/instruments. This makes my invention very safe to use and store around said machinery/instruments. Since the magnetic field is only momentary, the magnetizer/demagnetizer will not attract metallic shavings, metallic tools or other metallic objects.

(c) the hand-held, hand-powered or battery-powered electric magnetizer/demagnetizer makes it very easy to magnetize or demagnetize any ferromagnetic metallic shafts, including but not limited to screwdriver shafts, in a portable and mobile fashion—away from power outlets. This is very useful for a variety of mechanics, technicians, scientists, and hobbyists. It's small size makes it an easy addition to any tool chest.

(d) the hand-held hand-powered electric magnetizer/demagnetizer is not dependent on either power outlets or even batteries, allowing the user to be even more independent.

(e) the LED lights give useful feedback to the user indicating: the action state occurred (i.e. either the magnetization or demagnetization process has occurred); charging state; ready state.

(f) the electronic components of my magnetizer/demagnetizer can be used in machinery, devices, and/or processes to aid in the magnetization and demagnetization of various metallic shafts. This can be useful to applications in industry, scientific research, or even consumer products.

(g) the hand-held nature of my magnetizer/demagnetizer makes it a useful ergonomic tool. The socket limits complexity of usage. Simply put the item you wish to magnetize or demagnetize in the socket. Both operations are performed in the same place, and require no further complex physical motions from the user, beyond operational control of the magnetizer/demagnetizer and compression of the lever in the hand-powered version.

OPERATION--FIGS 1, 1A, 3, 4 AND 5

The manner of using the hand-held hand-powered magnetizer/demagnetizer is as follows: the user holds the magnetizer/demagnetizer contained in the outer casing 44 in either hand; places a metallic shaft, including but not limited to a screwdriver shaft 112, in the socket 96 which is contained inside the outer casing for the coils assembly 46. The user decides which operation to perform, either demagnetization or magnetization as appropriate, by selecting the correct position of switch 40 S1. The user then repeatedly presses and releases the lever 42, which supplies electrical power to the magnetizer/demagnetizer via the internal electric generator 10. As the lever is repeatedly being pressed firmly, the green LED 24 LED1 begins to light and increase in brightness. This indicates that the magnetizer/demagnetizer is being charged. Once the internal charge reaches a required threshold, the red LED 26 LED2 flashes brightly to indicate that the requested action, demagnetization or magnetization, has occurred. The average number of compressions to achieve the required threshold charge is between 4 to 5, but this depends of course on what kind of hand powered generator is being used, and can vary from one type to another.

The rest of the invention lies within the casing and its operation is best followed by referring to the schematic in FIG. 4. As the hand-powered AC generator 10 in the schematic provides electrical energy for the hand-powered hand-held magnetizer/demagnetizer, it begins to charge capacitor 14 C2. The capacitor 12 Cl, silicon diode 16 Dl, silicon diode 18 D2, and the charging capacitor 14 C2 form a voltage doubler. The resistor 30 R1, which is connected to a Zener diode 20 Z1, which is connected to a green LED 24 LED1 allow LED1 to light during the charging process, to indicate the charging of capacitor C2 is in progress. Resistor 32 R2 is connected, to a Zener diode 22 Z2, which is connected to the gate of SCR (silicon control rectifier) 28 Q1. At the appropriate voltage level, R2 and Z2 trigger Q1 to conduction. This allows current to flow through the line which is connected to the coil 80 L1, and also a red LED 26 LED2. LED2 flashes brightly indicating that the requested operation, magnetization or demagnetization, has occurred. The resistor 34 R3 is a limiting resistor for LED2. Major current flows through the coil 80 L1 and coil 82 L2 via the magnetize/demagnetize switch 40 S1. S1 determines the direction of magnetic flux of coil L2. In FIG. 5 the direction of magnetic flux in coil L2 is fixed allowing only the magnetize operation to be performed.

FIGS. 2, 2A, 3, 6 AND 7

The manner of using the hand-held battery-powered magnetizer/demagnetizer is as follows: the user holds the magnetizer/demagnetizer contained in the outer casing 98 in either hand; places a metallic shaft, including but not limited to a screwdriver shaft 112, in the socket 96 which is contained inside the outer casing 98. The user decides which operation to perform, either demagnetization or magnetization as appropriate, by selecting the correct position of switch 86 S1. The user then selects the charge position on the switch 88 S2. The magnetizer/demagnetizer immediately begins to charge, and the green LED 72 LED3 begins to light and gradually increase in brightness. This indicates that the magnetizer/demagnetizer is being charged. Once the internal charge reaches a required threshold, the green LED 68 LED1 lights up to indicate that the magnetizer/demagnetizer is fully charged, and ready to perform the desired operation, magnetization or demagnetization. The user then flips the switch 88 S2 from the charge position to the off or action position (the off position is the same as the action position). The red LED 70 LED2 flashes brightly to indicate that the required operation, magnetization or demagnetization, has occurred. The average charge time to achieve the required threshold charge is about 5 seconds depending on the quality and strength of the batteries being used (longer if the batteries are weak). If the user is using the external power connection 94 CN3 the charge time about 5 seconds.

The rest of the invention lies within the casing and its operation is best followed by referring to the schematic in FIG. 6. As the batteries contained in the battery connectors 50 CN1 and 52 CN2, or external power supplied via the 19V DC external power connector 94 CN3 provide electrical energy for the battery-powered hand-held magnetizer/demagnetizer, it begins to charge capacitor 66 C1. CN3 is connected to a protective diode 92 D1. The resistor 54 R1 limits the maximum charging current to the C1. The DPDT switch 88 S2 allows the charging of C1, or the discharge of C1. The IC 90 IC1 compares rising voltage on the charging capacitor C1 against the source voltage through resistor 58 R3 and resistor 56 R2. When these two voltages are equal, pin 6 becomes high. This allows the LED 68 LED1 to shine via the limiting resistor 60 R4. The resistor 84 R7, connected to Zener diode 76 Z2, connected to the LED 72 LED3 allows LED3 to shine and gradually increase in brightness during the charging process. R2 is further connected to Zener diode 74 Z1 which sets reference voltage for IC1. When the DPDT switch 88 S2 is disconnected from the positive line of the power circuitry (battery connectors 50 and 52, or external power connector 94), it allows the capacitor 66 C1 to discharge through resistor 62 R5 which is connected to the gate of SCR 78 Q1. This allows charge to move through Q1 to the coil 80 L1 and the LED 70 LED2. LED2 flashes brightly indicating that the requested operation, magnetization or demagnetization, has occurred. The resistor 64 R6 is a limiting resistor for LED2. L1 is connected to a DPDT switch 86 S1 which selects either magnetize or demagnetize. S1 is also connected to the second coil 82 L2. Major current flows through the coil 80 L1 and coil 82 L2 via S1. S1 determines the direction of magnetic flux of coil L2. In FIG. 7 the direction of magnetic flux in coil L2 is fixed, allowing only the magnetize operation to be performed.

Conclusion, Ramifications, and Scope

Accordingly, the reader will see that my magnetizer/demagnetizer can be used to magnetize or demagnetize a metallic shaft, including but not limited to a screwdriver shaft, easily and conveniently. Furthermore, the magnetizer/demagnetizer has the additional advantages in that

it produces a magnetic field only for an extremely short period of time during operation. While in storage, or when it is not being used, it produces no magnetic fields, thus it poses no danger to sensitive electronic and/or magnetic equipment.

it produces a magnetic field only for an extremely short period of time, and only when the user activates the magnetizer/demagnetizer to do so.

since it produces a magnetic field only for an extremely short period of time, it is not an permanent attractor of unwanted metallic shavings, metallic tools or other metallic objects

it provides a magnetization/demagnetization process which is easy to perform, and does not require a collection of various complex physical motions. The operation of the invention is reliable, simple and straightforward.

it provides a magnetization and demagnetization process which is electrically powered, but the apparatus is hand-held, compact, portable and mobile in nature, does not need to be connected to a power outlet, can easily fit on a tool belt, in a pant or shirt pocket, or in a tool box.

it provides a magnetization process which produces a very strong magnetized metallic shaft, much stronger than that which can be produced by portable magnet based magnetizers/demagnetizers.

it provides useful feedback to the user to indicate charging states, charging status, and action states.

it provides repeatable magnetizing and demagnetizing in rapid succession limited by available power supply.

Although the description above contains many specificities, these should not be construed as limiting the scope of the invention but as merely providing illustrations of some of the presently preferred embodiments of this invention. For example,

my magnetizer/demagnetizer can be utilized in connection with rotating shafts of various machinery to assist in gear switching by engaging and disengaging connecting shafts using magnetism. If used in this fashion, the version which provides for external power would be preferable, and inclusion of the LED feedback lights would be optional.

the size and diameter of the coils could be increased or decreased to provide for the magnetization/demagnetization of larger metallic shafts or more compact operations as appropriate.

the size, shape, and color of the outer casings can all be modified. The material used (i.e. plastic, metal, etc.) in the casing can also be modified.

the hand-powered electric generator is prior art and utilized solely as a source of power. Therefore different types of hand-powered electric generators can be used. In fact, other types of electric generators can be used, not limited to hand-powered versions. Higher voltage generators could be used for instance, which would allow the removal of the voltage doubler (12, 14, 16, 18). The AC generator could have coils with a higher number of turns in order to achieve higher output, allowing the removal or modification of the voltage doubler, and the addition of a voltage rectifier. Alternatively, a DC generator could be used.

if a higher voltage AC generator or power input is used then all resistor, zener diode, coil, SCR, and IC input line specifications may need to be adjusted proportionally to the increased voltage. In addition, certain resistors may need to be added before certain components.

the type of batteries used can be changed and thus are not limited to 9v batteries. Thus the battery connectors would have to be changed appropriately.

different types of DPDT switches can be used. For example sliding or flip DPDT switches can be used.

the comparison of internal circuit voltages which the IC 90 IC1 facilitates could be replaced by other combinations of electronic components, including but limited to SCR's and transistors.

different types and colors of LEDs can be used. The LEDs are used as indicators of various circuit states. This indication process could be facilitated by other means.

my magnetizer/demagnetizer provides independent magnetizing and demagnetizing process universally applicable to many more uses.

Thus the scope of the invention should be determined by the appended claims and their legal equivalents, rather than by the examples given.

I claim:

1. A method for electrically magnetizing and demagnetizing metallic tool shafts within an apparatus comprising:
(a) providing an apparatus which is compact and capable of being held in one hand, (b) providing a receiving socket which is able to hold at least one end of said metallic tool shaft,
(c) providing two coils which surround opposite halves of the predetermined shape of said socket,
(d) providing said metallic tool shaft and positioning said metallic tool shaft so that at least one end of said metallic tool shaft is inserted in said socket,
(e) providing a selection option for a desired process,
(f) providing an electrical power source which provides electrical current,
(g) providing an indicium at completion of desired process,
(h) emitting an electromagnetic field for only a fraction of a second.

2. The method of claim 1 wherein the electrical power source is a hand-powered alternating current generator.

3. The method of claim 1 wherein the electrical power source is an electrical battery, of quantity of at least one.

4. The method of claim 1 wherein the desired process is either magnetization or demagnetization; if the desired process is magnetization, then said current flows in same direction in both said coils; if the desired process is demagnetization, then said current flows in one of the coils in an opposite direction.

5. The method of claim 2 further comprising the step of:
driving the said generator with one hand, therefore charging the said apparatus to a predetermined level, at which point the said apparatus discharges and the desired process of either magnetization or demagnetization of said metallic tool shaft occurs. Wherein at said level a momentary magnetic field is released by said apparatus, and said indicium is produced.

6. The method of claim 3 further comprising the step of:
charging the said apparatus, and at a predetermined level the said apparatus is able to discharge and the desired process of either magnetization or demagnetization as said metallic tool shaft occurs. Wherein at said level a momentary magnetic field is released by said apparatus, and said indicium is produced.

7. An electrical magnetization and demagnetization apparatus which is compact and capable of being held in one hand, comprising:
(a) a receiving socket which is able to hold at least one end of a metallic tool shaft,
(b) two coils which surround opposite halves of the predetermined shape of said socket,
(c) a selection option for a desired process,
(d) operational means to emit an electromagnetic field for only a fraction of a second,
(e) an electrical power source for providing electrical current, and
(f) means for controllably directing current from said power source to a charge collecting device, and
(g) means for controllably directing current from said charge collecting device to said coils, whereby said metallic tool shaft will be either magnetized or demagnetized.

8. The apparatus of claim 7 wherein said selection option is facilitated by a selection switch, which offers the choice of said desired process, either magnetization or demagnetization.

9. The switch of claim 8 wherein said process of magnetization is facilitated by said switch which allows an electric current in the same direction in both said coils, and demagnetization is facilitated by said switch which allows an opposite current in one of the coils.

10. The apparatus of claim 9 wherein said electrical power source is a hand-powered alternating current generator.

11. The apparatus of claim 10, further including an indicium for increasing stored charge in said charge collecting device.

12. The apparatus of claim 10, further including an indicium at completion of said desired process.

13. The apparatus of claim 9 wherein said electrical power source is an electrical battery, of quantity of at least one.

14. The apparatus of claim 13, further including an indicium for increasing stored charge in said charge collecting device.

15. The apparatus of claim 13, further including an indicium at completion of said desired process.

16. The apparatus of claim 13, further including an indicium for predetermined sufficient stored charge in said charge collecting device.

17. The apparatus of claim 13, further including an external power source connection.
